(19) United States
(12) Patent Application Publication
(10) Pub. No.: US 2021/0174413 A1
(43) Pub. Date: Jun. 10, 2021

(54) METHODS AND SYSTEMS FOR FACILITATING THE MANAGEMENT OF RESOURCES BASED ON OFFERINGS AND REQUIREMENTS OF THE RESOURCES BY USERS

(71) Applicant: Morson Livingston, LAND O LAKES, FL (US)

(72) Inventor: Morson Livingston, LAND O LAKES, FL (US)

(21) Appl. No.: 16/703,590

(22) Filed: Dec. 4, 2019

(51) Int. Cl. G06Q 30/06; H04L 12/58; G06Q 20/12

(52) U.S. Cl. CPC G06Q 30/0609; G06Q 20/127; H04L 51/24

(57) ABSTRACT

Disclosed herein is a method of facilitating the management of resources based on offerings and requirements of the resources by users. Accordingly, the method may include a step of receiving a first offered resource and a first required resource from a first user device and a second offered resource and a second required resource from a second user device, a step of comparing and determining a match between the first offered resource and the first required resource with the second offered resource and the second required resource, a step of generating a first notification and a second notification based on the determining, a step of transmitting the first notification to the first user device and a step of transmitting the second notification to the second user device.

### TECHNICAL FIELD

Generally, the present disclosure relates to the field of data processing. More specifically, the present disclosure relates to methods and systems for facilitating the management of resources based on offerings and requirements of the resources by users.

### BACKGROUND

Existing techniques for facilitating the management of resources based on offerings and requirements of the resources by users are deficient with regard to several aspects. For instance, current technologies do not assist a user to adopt a pet based on a subscription. Furthermore, current technologies do not allow a first user to exchange resources (such as used items, services, new items, pets, etc.) with a second user based on the resources offered by the first user.

Therefore, there is a need for improved methods, systems, apparatuses and devices for facilitating the management of resources based on offerings and requirements of the resources by users that may overcome one or more of the above-mentioned problems and/or limitations.

### BRIEF SUMMARY

This summary is provided to introduce a selection of concepts in a simplified form, that are further described below in the Detailed Description. This summary is not intended to identify key features or essential features of the claimed subject matter. Nor is this summary intended to be used to limit the claimed subject matter's scope.

Disclosed herein is a method of facilitating the management of resources based on offerings and requirements of the resources by users, in accordance with some embodiments. Accordingly, the method may include a step of receiving, using a communication device, at least one first offered resource and at least one first required resource associated with a first user from a first user device. Further, the first user offers the at least one first offered resource and requires the at least one first required resource. Further, the at least one first required resource and the at one first offered resource may include at least one first item and at least one first service. Further, the method may include a step of receiving, using the communication device, at least one second offered resource and at least one second required resource associated with a second user from a second user device. Further, the second user offers the at least one second offered resource and requires the at least one second required resource. Further, the at least one second offered resource and the at least one second required resource may include at least one second item and the at least one second service. Further, the method may include a step of comparing, using a processing device, the at least one first offered resource and the at least one first required resource with the at least one second offered resource and the at least one second required resource. Further, the method may include a step of determining, using the processing device, at least one match between the at least one first offered resource and the at least one first required resource associated with the first user and the at least one second offered resource and the at least one second required resource associated with the second user based on the comparing. Further, the method may include a step of generating, using the processing device, at least one first notification and at least one second notification based on the determining. Further, the method may include a step of transmitting, using the communication device, the at least one first notification to the first user device. Further, the method may include a step of transmitting, using the communication device, the at least one second notification to the second user device.

Further disclosed herein is a system for facilitating the management of resources based on offerings and requirements of the resources by users, in accordance with some embodiments. Accordingly, the system may include a communication device configured for receiving at least one first offered resource and at least one first required resource associated with a first user from a first user device. Further, the first user offers the at least one first offered resource and requires the at least one first required resource. Further, the at least one first required resource and the at one first offered resource may include at least one first item and at least one first service. Further, the communication device may be configured for receiving at least one second offered resource and at least one second required resource associated with a second user from a second user device. Further, the second user offers the at least one second offered resource and requires the at least one second required resource. Further, the at least one second offered resource and the at least one second required resource may include at least one second item and the at least one second service. Further, the communication device may be configured for transmitting at least one first notification to the first user device. Further, the communication device may be configured for transmitting at least one second notification to the second user device. Further, the system may include a processing device configured for comparing the at least one first offered resource and the at least one first required resource with the at least one second offered resource and the at least one second required resource. Further, the processing device may be configured for determining at least one match between the at least one first offered resource and the at least one first required resource associated with the first user and the at least one second offered resource and the at least one second required resource associated with the second user based on the comparing. Further, the processing device may be configured for generating the at least one first notification and the at least one second notification based on the determining.

Both the foregoing summary and the following detailed description provide examples and are explanatory only. Accordingly, the foregoing summary and the following detailed description should not be considered to be restrictive. Further, features or variations may be provided in addition to those set forth herein. For example, embodiments may be directed to various feature combinations and sub-combinations described in the detailed description.

### BRIEF DESCRIPTION OF DRAWINGS

The accompanying drawings, which are incorporated in and constitute a part of this disclosure, illustrate various embodiments of the present disclosure. The drawings contain representations of various trademarks and copyrights owned by the Applicants. In addition, the drawings may contain other marks owned by third parties and are being used for illustrative purposes only. All rights to various trademarks and copyrights represented herein, except those belonging to their respective owners, are vested in and the property of the applicants. The applicants retain and reserve all rights in their trademarks and copyrights included herein, and grant permission to reproduce the material only in connection with reproduction of the granted patent and for no other purpose.

Furthermore, the drawings may contain text or captions that may explain certain embodiments of the present disclosure. This text is included for illustrative, non-limiting, explanatory purposes of certain embodiments detailed in the present disclosure.

FIG. 1 is an illustration of an online platform consistent with various embodiments of the present disclosure.

FIG. 2 is a block diagram of a system for facilitating the management of resources based on offerings and requirements of the resources by users, in accordance with some embodiments.

FIG. 3 is a flowchart of a method for facilitating the management of resources based on offerings and requirements of the resources by users, in accordance with some embodiments.

FIG. 4 is a flowchart of a method for facilitating the comparing of offered resources and required resources associated with a plurality of users, in accordance with some embodiments.

FIG. 5 is a flowchart of a method for facilitating the retrieving of offered resources and required resources associated with a plurality of users, in accordance with some embodiments.

FIG. 6 is a flowchart of a method for facilitating processing of a transaction based on user data, in accordance with some embodiments.

FIG. 7 is a block diagram of a computing device for implementing the methods disclosed herein, in accordance with some embodiments.

### DETAILED DESCRIPTION

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure, and are made merely for the purposes of providing a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim limitation found herein and/or issuing here from that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present disclosure. Accordingly, it is intended that the scope of patent protection is to be defined by the issued claim(s) rather than the description set forth herein.

Additionally, it is important to note that each term used herein refers to that which an ordinary artisan would understand such term to mean based on the contextual use of such term herein. To the extent that the meaning of a term used herein—as understood by the ordinary artisan based on the contextual use of such term—differs in any way from any particular dictionary definition of such term, it is intended that the meaning of the term as understood by the ordinary artisan should prevail.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.”

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the claims found herein and/or issuing here from. The present disclosure contains headers. It should be understood that these headers are used as references and are not to be construed as limiting upon the subjected matter disclosed under the header.

The present disclosure includes many aspects and features. Moreover, while many aspects and features relate to, and are described in the context of methods and systems for facilitating the management of resources based on offerings and requirements of the resources by users, embodiments of the present disclosure are not limited to use only in this context.

In general, the method disclosed herein may be performed by one or more computing devices. For example, in some embodiments, the method may be performed by a server computer in communication with one or more client devices over a communication network such as, for example, the Internet. In some other embodiments, the method may be performed by one or more of at least one server computer, at least one client device, at least one network device, at least one sensor and at least one actuator. Examples of the one or more client devices and/or the server computer may include, a desktop computer, a laptop computer, a tablet computer, a personal digital assistant, a portable electronic device, a wearable computer, a smart phone, an Internet of Things (IoT) device, a smart electrical appliance, a video game console, a rack server, a super-computer, a mainframe computer, mini-computer, micro-computer, a storage server, an application server (e.g. a mail server, a web server, a real-time communication server, an FTP server, a virtual server, a proxy server, a DNS server etc.), a quantum computer, and so on. Further, one or more client devices and/or the server computer may be configured for executing a software application such as, for example, but not limited to, an operating system (e.g. Windows, Mac OS, Unix, Linux, Android, etc.) in order to provide a user interface (e.g. GUI, touch-screen based interface, voice based interface, gesture based interface etc.) for use by the one or more users and/or a network interface for communicating with other devices over a communication network. Accordingly, the server computer may include a processing device configured for performing data processing tasks such as, for example, but not limited to, analyzing, identifying, determining, generating, transforming, calculating, computing, compressing, decompressing, encrypting, decrypting, scrambling, splitting, merging, interpolating, extrapolating, redacting, anonymizing, encoding and decoding. Further, the server computer may include a communication device configured for communicating with one or more external devices. The one or more external devices may include, for example, but are not limited to, a client device, a third party database, public database, a private database and so on. Further, the communication device may be configured for communicating with the one or more external devices over one or more communication channels. Further, the one or more communication channels may include a wireless communication channel and/or a wired communication channel. Accordingly, the communication device may be configured for performing one or more of transmitting and receiving of information in electronic form. Further, the server computer may include a storage device configured for performing data storage and/or data retrieval operations. In general, the storage device may be configured for providing reliable storage of digital information. Accordingly, in some embodiments, the storage device may be based on technologies such as, but not limited to, data compression, data backup, data redundancy, deduplication, error correction, data finger-printing, role based access control, and so on.

Further, one or more steps of the method disclosed herein may be initiated, maintained, controlled and/or terminated based on a control input received from one or more devices operated by one or more users such as, for example, but not limited to, an end user, an admin, a service provider, a service consumer, an agent, a broker and a representative thereof. Further, the user as defined herein may refer to a human, an animal or an artificially intelligent being in any state of existence, unless stated otherwise, elsewhere in the present disclosure. Further, in some embodiments, the one or more users may be required to successfully perform authentication in order for the control input to be effective. In general, a user of the one or more users may perform authentication based on the possession of a secret human readable secret data (e.g. username, password, passphrase, PIN, secret question, secret answer etc.) and/or possession of a machine readable secret data (e.g. encryption key, decryption key, bar codes, etc.) and/or or possession of one or more embodied characteristics unique to the user (e.g. biometric variables such as, but not limited to, fingerprint, palm-print, voice characteristics, behavioral characteristics, facial features, iris pattern, heart rate variability, evoked potentials, brain waves, and so on) and/or possession of a unique device (e.g. a device with a unique physical and/or chemical and/or biological characteristic, a hardware device with a unique serial number, a network device with a unique IP/MAC address, a telephone with a unique phone number, a smartcard with an authentication token stored thereupon, etc.). Accordingly, the one or more steps of the method may include communicating (e.g. transmitting and/or receiving) with one or more sensor devices and/or one or more actuators in order to perform authentication. For example, the one or more steps may include receiving, using the communication device, the secret human readable data from an input device such as, for example, a keyboard, a keypad, a touch-screen, a microphone, a camera and so on. Likewise, the one or more steps may include receiving, using the communication device, the one or more embodied characteristics from one or more biometric sensors.

Further, one or more steps of the method may be automatically initiated, maintained and/or terminated based on one or more predefined conditions. In an instance, the one or more predefined conditions may be based on one or more contextual variables. In general, the one or more contextual variables may represent a condition relevant to the performance of the one or more steps of the method. The one or more contextual variables may include, for example, but are not limited to, location, time, identity of a user associated with a device (e.g. the server computer, a client device etc.) corresponding to the performance of the one or more steps, environmental variables (e.g. temperature, humidity, pressure, wind speed, lighting, sound, etc.) associated with a device corresponding to the performance of the one or more steps, physical state and/or physiological state and/or psychological state of the user, physical state (e.g. motion, direction of motion, orientation, speed, velocity, acceleration, trajectory, etc.) of the device corresponding to the performance of the one or more steps and/or semantic content of data associated with the one or more users. Accordingly, the one or more steps may include communicating with one or more sensors and/or one or more actuators associated with the one or more contextual variables. For example, the one or more sensors may include, but are not limited to, a timing device (e.g. a real-time clock), a location sensor (e.g. a GPS receiver, a GLONASS receiver, an indoor location sensor etc.), a biometric sensor (e.g. a fingerprint sensor), an environmental variable sensor (e.g. temperature sensor, humidity sensor, pressure sensor, etc.) and a device state sensor (e.g. a power sensor, a voltage/current sensor, a switch-state sensor, a usage sensor, etc. associated with the device corresponding to performance of the or more steps).

Further, the one or more steps of the method may be performed one or more number of times. Additionally, the one or more steps may be performed in any order other than as exemplarily disclosed herein, unless explicitly stated otherwise, elsewhere in the present disclosure. Further, two or more steps of the one or more steps may, in some embodiments, be simultaneously performed, at least in part. Further, in some embodiments, there may be one or more time gaps between performance of any two steps of the one or more steps.

Further, in some embodiments, the one or more predefined conditions may be specified by the one or more users. Accordingly, the one or more steps may include receiving, using the communication device, the one or more predefined conditions from one or more and devices operated by the one or more users. Further, the one or more predefined conditions may be stored in the storage device. Alternatively, and/or additionally, in some embodiments, the one or more predefined conditions may be automatically determined, using the processing device, based on historical data corresponding to performance of the one or more steps. For example, the historical data may be collected, using the storage device, from a plurality of instances of performance of the method. Such historical data may include performance actions (e.g. initiating, maintaining, interrupting, terminating, etc.) of the one or more steps and/or the one or more contextual variables associated therewith. Further, machine learning may be performed on the historical data in order to determine the one or more predefined conditions. For instance, machine learning on the historical data may determine a correlation between one or more contextual variables and performance of the one or more steps of the method. Accordingly, the one or more predefined conditions may be generated, using the processing device, based on the correlation.

Further, one or more steps of the method may be performed at one or more spatial locations. For instance, the method may be performed by a plurality of devices interconnected through a communication network. Accordingly, in an example, one or more steps of the method may be performed by a server computer. Similarly, one or more steps of the method may be performed by a client computer. Likewise, one or more steps of the method may be performed by an intermediate entity such as, for example, a proxy server. For instance, one or more steps of the method may be performed in a distributed fashion across the plurality of devices in order to meet one or more objectives. For example, one objective may be to provide load balancing between two or more devices. Another objective may be to restrict a location of one or more of an input data, an output data and any intermediate data therebetween corresponding to one or more steps of the method. For example, in a client-server environment, sensitive data corresponding to a user may not be allowed to be transmitted to the server computer. Accordingly, one or more steps of the method operating on the sensitive data and/or a derivative thereof may be performed at the client device.

Overview:

The present disclosure may describe methods and systems for facilitating the management of resources based on offerings and requirements of the resources by users. Further, the disclosed system may include an app (or mobile application) that may enable people to give anything for free. Further, end-users may have to pay a subscription to find details and contact information. Further, the app may facilitate free adoption of pets. Further, the end-users may also exchange goods, services, etc. Even though the disclosed system has numerous features of e-commerce, the disclosed system may include a platform for connecting providers and end-users.

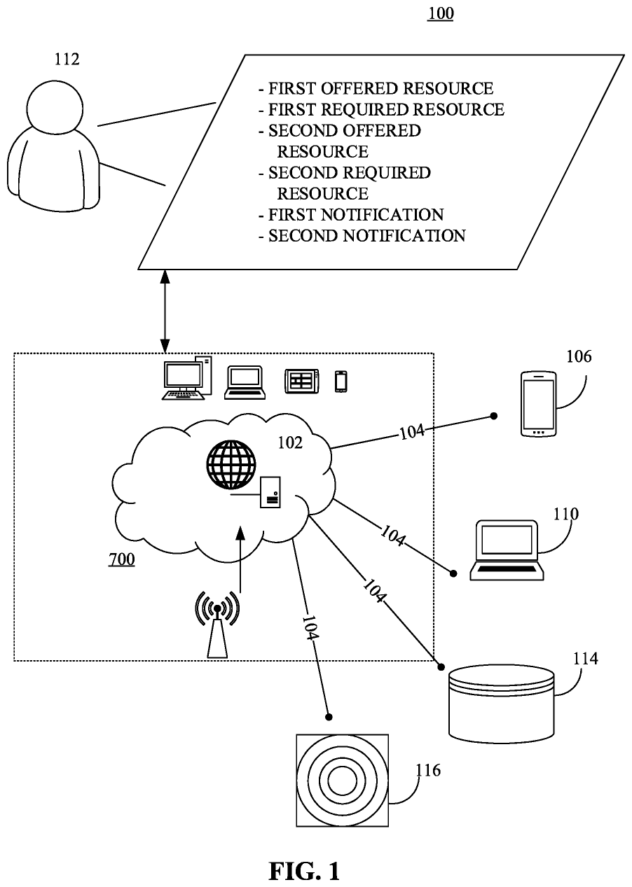

FIG. 1 is an illustration of an online platform 100 consistent with various embodiments of the present disclosure. By way of non-limiting example, the online platform 100 to facilitate the management of resources based on offerings and requirements of the resources by users may be hosted on a centralized server 102, such as, for example, a cloud computing service. The centralized server 102 may communicate with other network entities, such as, for example, a mobile device 106 (such as a smartphone, a laptop, a tablet computer etc.), other electronic devices 110 (such as desktop computers, server computers etc.), databases 114, and sensors 116 over a communication network 104, such as, but not limited to, the Internet. Further, users of the online platform 100 may include relevant parties such as, but not limited to, end-users, administrators, service providers, service consumers and so on. Accordingly, in some instances, electronic devices operated by the one or more relevant parties may be in communication with the platform.

A user 112, such as the one or more relevant parties, may access online platform 100 through a web based software application or browser. The web based software application may be embodied as, for example, but not be limited to, a website, a web application, a desktop application, and a mobile application compatible with a computing device 700.

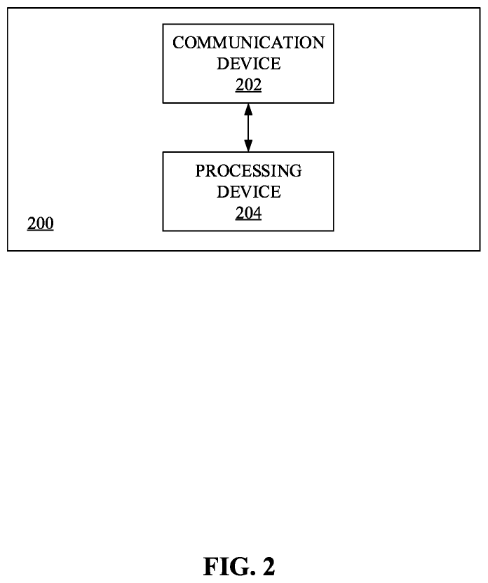

FIG. 2 is a block diagram of a system 200 for facilitating the management of resources based on offerings and requirements of the resources by users, in accordance with some embodiments. Accordingly, the system 200 may include a communication device 202 and a processing device 204.

Further, the communication device 202 may be configured for receiving at least one first offered resource and at least one first required resource associated with a first user from a first user device. Further, the first user offers the at least one first offered resource and requires the at least one first required resource. Further, the at least one first required resource and the at one first offered resource may include at least one first item and at least one first service. Further, the communication device 202 may be configured for receiving at least one second offered resource and at least one second required resource associated with a second user from a second user device. Further, the second user offers the at least one second offered resource and requires the at least one second required resource. Further, the at least one second offered resource and the at least one second required resource may include at least one second item and the at least one second service. Further, the communication device 202 may be configured for transmitting at least one first notification to the first user device. Further, the communication device 202 may be configured for transmitting at least one second notification to the second user device.

Further, the processing device 204 may be configured for comparing the at least one first offered resource and the at least one first required resource with the at least one second offered resource and the at least one second required resource. Further, the processing device 204 may be configured for determining at least one match between the at least one first offered resource and the at least one first required resource associated with the first user and the at least one second offered resource and the at least one second required resource associated with the second user based on the comparing. Further, the processing device 204 may be configured for generating the at least one first notification and the at least one second notification based on the determining.

Further, in some embodiments, the at least one first notification may be identical to the at least one second notification. Further, the communication device 202 may be further configured for transmitting the at least one first notification to the first user device and the second user device.

Further, in some embodiments, the comparing may include comparing of the at least one first item with the at least one second item and comparing of the at least one first service with the at least one second service.

Further, in some embodiments, the at least one first item, the at least one first service, the at least one second item, and the at least one second service may be associated with at least one value. Further, the comparing may include comparing the at least one first item of a first value of the at least one value with the at least one second item of the first value and the at least one second service of the first value and comparing the at least one first service of a second value of the at least one value with the at least one second item of the second value and the at least one second service of the second value.

Further, in some embodiments, the at least one first offered resource may include at least one pet animal. Further, the first user offers the at least one pet animal. Further, the at least one second required resource may include the at least one pet animal. Further, the second user requires the at least one pet animal. Further, the at least one match between the at least one first offered resource and the at least one second required resource facilitates an adoption of the at least one pet by the second user from the first user.

Further, in some embodiments, the communication device 202 may be further configured for receiving at least one first condition associated with the at least one first offered resource and the at least one first required resource from the first user device. Further, the communication device 202 may be configured for receiving at least one second condition associated with the at least one second offered resource and the at least one second required resource from the second user device. Further, the processing device 204 may be further configured for comparing the at least one first offered resource and the at least one first required resource with the at least one second offered resource and the at least one second required resource based on the at least one first condition and the at least one second condition. Further, the determining of the at least one match may be based on the comparing.

Further, in some embodiments, the at least one match between the at least one first offered resource and the at least one second required resource and the at least one second offered resource and the at least one first required resource facilitates an exchange of the at least one first offered resource and the at least one second offered resource between the first user and the second user.

Further, in some embodiments, the at least one match between the at least one first offered resource and the at least one second required resource facilitates a donation of the at least one first offered resource from the first user to the second user. Further, the at least one match between the at least one second offered resource and the at least one first required resource facilitates the donation of the at least one second offered resource from the second user to the first user.

Further, in some embodiments, the communication device 202 may be further configured for receiving a first user indication associated with the first user from the first user device. Further, the communication device 202 may be configured for receiving a second user indication associated with the second user from the second user device. Further, the system 200 may include a storage device (not shown) communicatively coupled with the communication device 202. Further, the storage device may be configured for retrieving the at least one first offered resource and the at least one first required resource associated with the first user based on the first user indication and the at least one second offered resource and the at least one second required resource associated with the second user based on the second user indication. Further, the determining of the at least one match may be based on the comparing.

Further, in some embodiments, the communication device 202 may be further configured for receiving first user data from the first user device. Further, the communication device 202 may be configured for receiving second user data from the second user device. Further, the processing device 204 may be further configured for identifying a first subscription payment corresponding to the first user and a second subscription payment corresponding to the second user based on the determining. Further, the processing device 204 may be configured for processing a first transaction corresponding to the first subscription payment based on the first user data and a second transaction corresponding to the second subscription payment based on the second user data. Further, the at least one first notification may be transmitted to the first user and the at least one second notification may be transmitted to the second user.

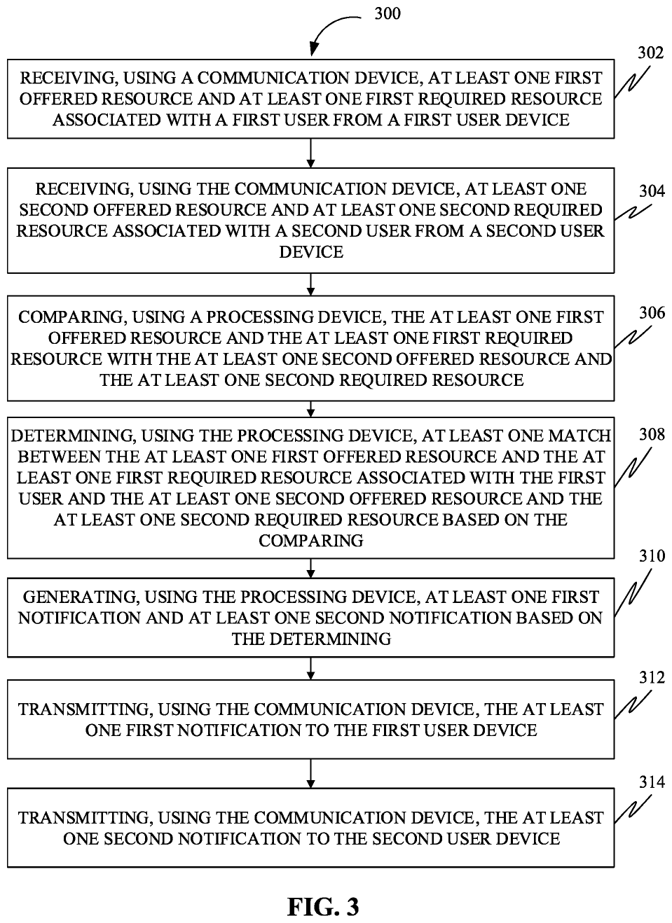

FIG. 3 is a flowchart of a method 300 for facilitating the management of resources based on offerings and requirements of the resources by users, in accordance with some embodiments. Accordingly, at 302, the method 300 may include a step of receiving, using a communication device, at least one first offered resource and at least one first required resource associated with a first user from a first user device. Further, the first user offers the at least one first offered resource and requires the at least one first required resource. Further, the at least one first required resource and the at one first offered resource may include at least one first item and at least one first service.

Further, at 304, the method 300 may include a step of receiving, using the communication device, at least one second offered resource and at least one second required resource associated with a second user from a second user device. Further, the second user offers the at least one second offered resource and requires the at least one second required resource. Further, the at least one second offered resource and the at least one second required resource may include at least one second item and the at least one second service.

Further, at 306, the method 300 may include a step of comparing, using a processing device, the at least one first offered resource and the at least one first required resource with the at least one second offered resource and the at least one second required resource.

Further, at 308, the method 300 may include a step of determining, using the processing device, at least one match between the at least one first offered resource and the at least one first required resource associated with the first user and the at least one second offered resource and the at least one second required resource associated with the second user based on the comparing.

Further, at 310, the method 300 may include a step of generating, using the processing device, at least one first notification and at least one second notification based on the determining.

Further, at 312, the method 300 may include a step of transmitting, using the communication device, the at least one first notification to the first user device.

Further, at 314, the method 300 may include a step of transmitting, using the communication device, the at least one second notification to the second user device.

Further, in some embodiments, the at least one first notification may be identical to the at least one second notification. Further, the method further may include transmitting, using the communication device, the at least one first notification to the first user device and the second user device.

Further, in some embodiments, the comparing may include comparing of the at least one first item with the at least one second item and comparing of the at least one first service with the at least one second service.

Further, in some embodiments, the at least one first item, the at least one first service, the at least one second item, and the at least one second service may be associated with at least one value. Further, the comparing may include comparing the at least one first item of a first value of the at least one value with the at least one second item of the first value and the at least one second service of the first value and comparing the at least one first service of a second value of the at least one value with the at least one second item of the second value and the at least one second service of the second value.

Further, in some embodiments, the at least one first offered resource may include at least one pet animal. Further, the first user offers the at least one pet animal. Further, the at least one second required resource may include the at least one pet animal. Further, the second user requires the at least one pet animal. Further, the at least one match between the at least one first offered resource and the at least one second required resource facilitates an adoption of the at least one pet by the second user from the first user.

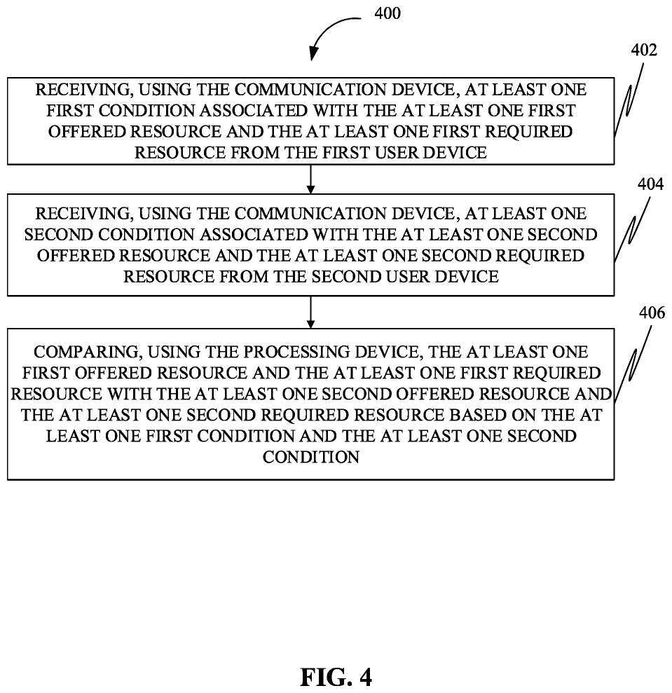

FIG. 4 is a flowchart of a method 400 for facilitating the comparing of offered resources and required resources associated with a plurality of users, in accordance with some embodiments. Accordingly, at 402, the method 400 may include a step of receiving, using the communication device, at least one first condition associated with the at least one first offered resource and the at least one first required resource from the first user device.

Further, at 404, the method 400 may include a step of receiving, using the communication device, at least one second condition associated with the at least one second offered resource and the at least one second required resource from the second user device.

Further, at 406, the method 400 may include a step of comparing, using the processing device, the at least one first offered resource and the at least one first required resource with the at least one second offered resource and the at least one second required resource based on the at least one first condition and the at least one second condition. Further, the determining of the at least one match may be based on the comparing.

Further, in some embodiments, the at least one match between the at least one first offered resource and the at least one second required resource and the at least one second offered resource and the at least one first required resource facilitates an exchange of the at least one first offered resource and the at least one second offered resource between the first user and the second user.

Further, in some embodiments, the at least one match between the at least one first offered resource and the at least one second required resource facilitates a donation of the at least one first offered resource from the first user to the second user. Further, the at least one match between the at least one second offered resource and the at least one first required resource facilitates the donation of the at least one second offered resource from the second user to the first user.

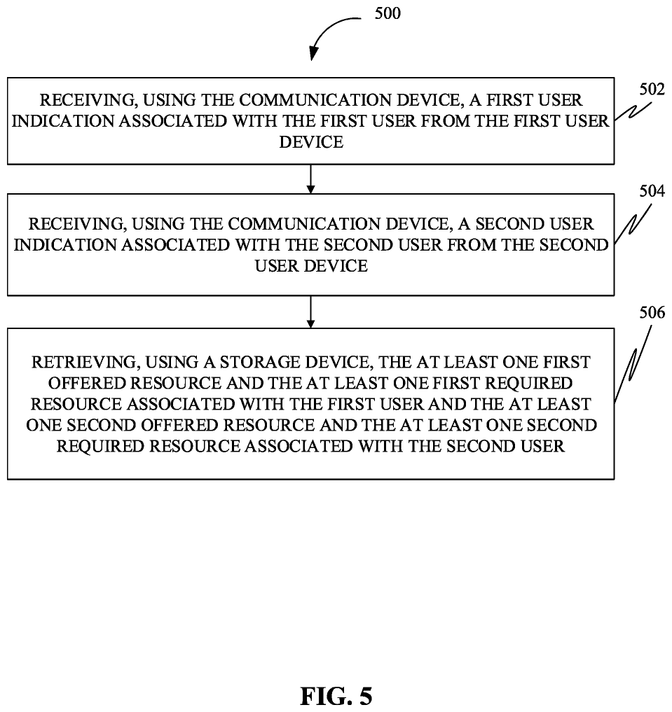

FIG. 5 is a flowchart of a method 500 for facilitating the retrieving of offered resources and required resources associated with a plurality of users, in accordance with some embodiments. Accordingly, at 502, the method 500 may include a step of receiving, using the communication device, a first user indication associated with the first user from the first user device.

Further, at 504, the method 500 may include a step of receiving, using the communication device, a second user indication associated with the second user from the second user device.

Further, at 506, the method 500 may include a step of retrieving, using a storage device, the at least one first offered resource and the at least one first required resource associated with the first user based on the first user indication and the at least one second offered resource and the at least one second required resource associated with the second user based on the second user indication. Further, the determining of the at least one match may be based on the comparing.

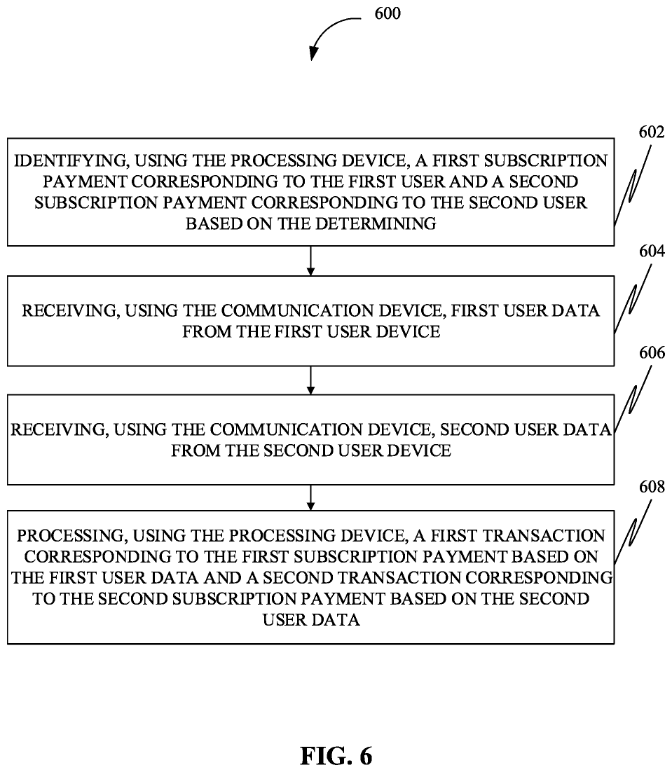

FIG. 6 is a flowchart of a method 600 for facilitating processing of a transaction based on user data, in accordance with some embodiments. Accordingly, at 602, the method 600 may include a step of identifying, using the processing device, a first subscription payment corresponding to the first user and a second subscription payment corresponding to the second user based on the determining.

Further, at 604, the method 600 may include a step of receiving, using the communication device, first user data from the first user device.

Further, at 606, the method 600 may include a step of receiving, using the communication device, second user data from the second user device.

Further, at 608, the method 600 may include a step of processing, using the processing device, a first transaction corresponding to the first subscription payment based on the first user data and a second transaction corresponding to the second subscription payment based on the second user data. Further, the at least one first notification may be transmitted to the first user and the at least one second notification may be transmitted to the second user.

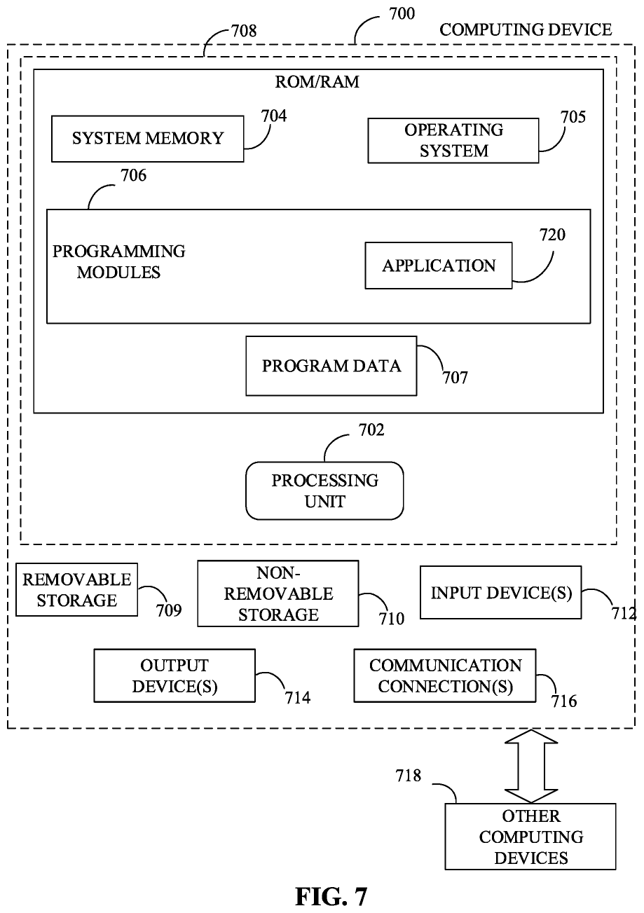

With reference to FIG. 7, a system consistent with an embodiment of the disclosure may include a computing device or cloud service, such as computing device 700. In a basic configuration, computing device 700 may include at least one processing unit 702 and a system memory 704. Depending on the configuration and type of computing device, system memory 704 may comprise, but is not limited to, volatile (e.g. random-access memory (RAM)), non-volatile (e.g. read-only memory (ROM)), flash memory, or any combination. System memory 704 may include operating system 705, one or more programming modules 706, and may include a program data 707. Operating system 705, for example, may be suitable for controlling computing device 700's operation. In one embodiment, programming modules 706 may include image-processing module, machine learning module. Furthermore, embodiments of the disclosure may be practiced in conjunction with a graphics library, other operating systems, or any other application program and is not limited to any particular application or system. This basic configuration is illustrated in FIG. 7 by those components within a dashed line 708.

Computing device 700 may have additional features or functionality. For example, computing device 700 may also include additional data storage devices (removable and/or non-removable) such as, for example, magnetic disks, optical disks, or tape. Such additional storage is illustrated in FIG. 7 by a removable storage 709 and a non-removable storage 710. Computer storage media may include volatile and non-volatile, removable and non-removable media implemented in any method or technology for storage of information, such as computer-readable instructions, data structures, program modules, or other data. System memory 704, removable storage 709, and non-removable storage 710 are all computer storage media examples (i.e., memory storage.) Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by computing device 700. Any such computer storage media may be part of device 700. Computing device 700 may also have input device(s) 712 such as a keyboard, a mouse, a pen, a sound input device, a touch input device, a location sensor, a camera, a biometric sensor, etc. Output device(s) 714 such as a display, speakers, a printer, etc. may also be included. The aforementioned devices are examples and others may be used.

Computing device 700 may also contain a communication connection 716 that may allow device 700 to communicate with other computing devices 718, such as over a network in a distributed computing environment, for example, an intranet or the Internet. Communication connection 716 is one example of communication media. Communication media may typically be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media. The term computer readable media as used herein may include both storage media and communication media.

As stated above, a number of program modules and data files may be stored in system memory 704, including operating system 705. While executing on processing unit 702, programming modules 706 (e.g., application 720 such as a media player) may perform processes including, for example, one or more stages of methods, algorithms, systems, applications, servers, databases as described above. The aforementioned process is an example, and processing unit 702 may perform other processes.

Generally, consistent with embodiments of the disclosure, program modules may include routines, programs, components, data structures, and other types of structures that may perform particular tasks or that may implement particular abstract data types. Moreover, embodiments of the disclosure may be practiced with other computer system configurations, including hand-held devices, general purpose graphics processor-based systems, multiprocessor systems, microprocessor-based or programmable consumer electronics, application specific integrated circuit-based electronics, minicomputers, mainframe computers, and the like. Embodiments of the disclosure may also be practiced in distributed computing environments where tasks are performed by remote processing devices that are linked through a communications network. In a distributed computing environment, program modules may be located in both local and remote memory storage devices.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. Embodiments of the disclosure may also be practiced using other technologies capable of performing logical operations such as, for example, AND, OR, and NOT, including but not limited to mechanical, optical, fluidic, and quantum technologies. In addition, embodiments of the disclosure may be practiced within a general-purpose computer or in any other circuits or systems.

Embodiments of the disclosure, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present disclosure may be embodied in hardware and/or in software (including firmware, resident software, micro-code, etc.). In other words, embodiments of the present disclosure may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random-access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Embodiments of the present disclosure, for example, are described above with reference to block diagrams and/or operational illustrations of methods, systems, and computer program products according to embodiments of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While certain embodiments of the disclosure have been described, other embodiments may exist. Furthermore, although embodiments of the present disclosure have been described as being associated with data stored in memory and other storage mediums, data can also be stored on or read from other types of computer-readable media, such as secondary storage devices, like hard disks, solid state storage (e.g., USB drive), or a CD-ROM, a carrier wave from the Internet, or other forms of RAM or ROM. Further, the disclosed methods' stages may be modified in any manner, including by reordering stages and/or inserting or deleting stages, without departing from the disclosure.

Although the present disclosure has been explained in relation to its preferred embodiment, it is to be understood that many other possible modifications and variations can be made without departing from the spirit and scope of the disclosure.

The following is claimed:

1. A method for facilitating the management of resources based on offerings and requirements of the resources by users, the method comprising:
receiving, using a communication device, at least one first offered resource and at least one first required resource associated with a first user from a first user device, wherein the first user offers the at least one first offered resource and requires the at least one first required resource, wherein the at least one first required resource and the at one first offered resource comprises at least one first item and at least one first service;
receiving, using the communication device, at least one second offered resource and at least one second required resource associated with a second user from a second user device, wherein the second user offers the at least one second offered resource and requires the at least one second required resource, wherein the at least one second offered resource and the at least one second required resource comprises at least one second item and the at least one second service;
comparing, using a processing device, the at least one first offered resource and the at least one first required resource with the at least one second offered resource and the at least one second required resource;
determining, using the processing device, at least one match between the at least one first offered resource and the at least one first required resource associated with the first user and the at least one second offered resource and the at least one second required resource associated with the second user based on the comparing;
generating, using the processing device, at least one first notification and at least one second notification based on the determining; and
transmitting, using the communication device, the at least one first notification to the first user device; and
transmitting, using the communication device, the at least one second notification to the second user device.

2. The method of claim 1, wherein the at least one first notification is identical to the at least one second notification, wherein the method further comprising transmitting, using the communication device, the at least one first notification to the first user device and the second user device.

3. The method of claim 1, wherein the comparing comprises comparing of the at least one first item with the at least one second item and comparing of the at least one first service with the at least one second service.

4. The method of claim 1, wherein the at least one first item, the at least one first service, the at least one second item, and the at least one second service is associated with at least one value, wherein the comparing comprises comparing the at least one first item of a first value of the at least one value with the at least one second item of the first value and the at least one second service of the first value and comparing the at least one first service of a second value of the at least one value with the at least one second item of the second value and the at least one second service of the second value.

5. The method of claim 1, wherein the at least one first offered resource comprises at least one pet animal, wherein the first user offers the at least one pet animal, wherein the at least one second required resource comprises the at least one pet animal, wherein the second user requires the at least one pet animal, wherein the at least one match between the at least one first offered resource and the at least one second required resource facilitates an adoption of the at least one pet by the second user from the first user.

6. The method of claim 1 further comprising:
receiving, using the communication device, at least one first condition associated with the at least one first offered resource and the at least one first required resource from the first user device;
receiving, using the communication device, at least one second condition associated with the at least one second offered resource and the at least one second required resource from the second user device,
comparing, using the processing device, the at least one first offered resource and the at least one first required resource with the at least one second offered resource and the at least one second required resource based on the at least one first condition and the at least one second condition, wherein the determining of the at least one match is based on the comparing.

7. The method of claim 1, wherein the at least one match between the at least one first offered resource and the at least one second required resource and the at least one second offered resource and the at least one first required resource facilitates an exchange of the at least one first offered resource and the at least one second offered resource between the first user and the second user.

8. The method of claim 1, wherein the at least one match between the at least one first offered resource and the at least one second required resource facilitates a donation of the at least one first offered resource from the first user to the second user, wherein the at least one match between the at least one second offered resource and the at least one first required resource facilitates the donation of the at least one second offered resource from the second user to the first user.

9. The method of claim 1 comprising:
receiving, using the communication device, a first user indication associated with the first user from the first user device;
receiving, using the communication device, a second user indication associated with the second user from the second user device; and
retrieving, using a storage device, the at least one first offered resource and the at least one first required resource associated with the first user based on the first user indication and the at least one second offered resource and the at least one second required resource associated with the second user based on the second user indication, wherein the determining of the at least one match is based on the comparing.

10. The method of claim 1 further comprising:
identifying, using the processing device, a first subscription payment corresponding to the first user and a second subscription payment corresponding to the second user based on the determining;
receiving, using the communication device, first user data from the first user device;
receiving, using the communication device, second user data from the second user device;
processing, using the processing device, a first transaction corresponding to the first subscription payment based on the first user data and a second transaction corresponding to the second subscription payment based on the second user data, wherein the at least one first notification is transmitted to the first user and the at least one second notification is transmitted to the second user.

11. A system for facilitating the management of resources based on offerings and requirements of the resources by users, the system comprising:
a communication device configured for:
receiving at least one first offered resource and at least one first required resource associated with a first user from a first user device, wherein the first user offers the at least one first offered resource and requires the at least one first required resource, wherein the at least one first required resource and the at one first offered resource comprises at least one first item and at least one first service;
receiving at least one second offered resource and at least one second required resource associated with a second user from a second user device, wherein the second user offers the at least one second offered resource and requires the at least one second required resource, wherein the at least one second offered resource and the at least one second required resource comprises at least one second item and the at least one second service;
transmitting at least one first notification to the first user device;
transmitting at least one second notification to the second user device;
a processing device configured for:
comparing the at least one first offered resource and the at least one first required resource with the at least one second offered resource and the at least one second required resource;
determining at least one match between the at least one first offered resource and the at least one first required resource associated with the first user and the at least one second offered resource and the at least one second required resource associated with the second user based on the comparing; and
generating the at least one first notification and the at least one second notification based on the determining.

12. The system of claim 11, wherein the at least one first notification is identical to the at least one second notification, wherein the communication device is further configured for transmitting the at least one first notification to the first user device and the second user device.

13. The system of claim 11, wherein the comparing comprises comparing of the at least one first item with the at least one second item and comparing of the at least one first service with the at least one second service.

14. The system of claim 11, wherein the at least one first item, the at least one first service, the at least one second item, and the at least one second service is associated with at least one value, wherein the comparing comprises comparing the at least one first item of a first value of the at least one value with the at least one second item of the first value and the at least one second service of the first value and comparing the at least one first service of a second value of the at least one value with the at least one second item of the second value and the at least one second service of the second value.

15. The system of claim 11, wherein the at least one first offered resource comprises at least one pet animal, wherein the first user offers the at least one pet animal, wherein the at least one second required resource comprises the at least one pet animal, wherein the second user requires the at least one pet animal, wherein the at least one match between the at least one first offered resource and the at least one second required resource facilitates an adoption of the at least one pet by the second user from the first user.

16. The system of claim 11, wherein the communication device is further configured for:
receiving at least one first condition associated with the at least one first offered resource and the at least one first required resource from the first user device; and
receiving at least one second condition associated with the at least one second offered resource and the at least one second required resource from the second user device, wherein the processing device is further configured for comparing the at least one first offered resource and the at least one first required resource with the at least one second offered resource and the at least one second required resource based on the at least one first condition and the at least one second condition, wherein the determining of the at least one match is based on the comparing.

17. The system of claim 11, wherein the at least one match between the at least one first offered resource and the at least one second required resource and the at least one second offered resource and the at least one first required resource facilitates an exchange of the at least one first offered resource and the at least one second offered resource between the first user and the second user.

18. The system of claim 11, wherein the at least one match between the at least one first offered resource and the at least one second required resource facilitates a donation of the at least one first offered resource from the first user to the second user, wherein the at least one match between the at least one second offered resource and the at least one first required resource facilitates the donation of the at least one second offered resource from the second user to the first user.

19. The system of claim 11, wherein the communication device is further configured for
receiving a first user indication associated with the first user from the first user device; and
receiving a second user indication associated with the second user from the second user device, wherein the system further comprising a storage device communicatively coupled with the communication device, wherein the storage device is configured for retrieving the at least one first offered resource and the at least one first required resource associated with the first user based on the first user indication and the at least one second offered resource and the at least one second required resource associated with the second user based on the second user indication, wherein the determining of the at least one match is based on the comparing.

20. The system of claim 11, wherein the communication device is further configured for:
receiving first user data from the first user device;
receiving second user data from the second user device, wherein the processing device is further configured for:
identifying a first subscription payment corresponding to the first user and a second subscription payment corresponding to the second user based on the determining; and
processing a first transaction corresponding to the first subscription payment based on the first user data and a second transaction corresponding to the second subscription payment based on the second user data, wherein the at least one first notification is transmitted to the first user and the at least one second notification is transmitted to the second user.
